(19) United States
(12) Patent Application Publication
(10) Pub. No.: US 2005/0200049 A1
(43) Pub. Date: Sep. 15, 2005

(54) Method of manufacturing airbag cover

(75) Inventor: Naoki Soejima, Kanzaki-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/061,549

(22) Filed: Feb. 18, 2005

(30) Foreign Application Priority Data
Feb. 19, 2004 (JP) 2004-042540

(51) Int. Cl. B06B 1/02

(52) U.S. Cl. 264/442

(57) ABSTRACT

Method of reliably manufacturing an airbag cover for covering a vehicle airbag, an airbag cover is processed with an ultrasonic processing blade and a tear line having a depth in a range of the plate thickness of the airbag cover is formed. At this time, a member to be taught profiles along a teaching line which is formed in an airbag cover supporting surface of an airbag cover supporting member, such that profiling data is derived and obtained. And then, a profiling teaching step which teaches a control unit based on profiling data is provided.

### BACKGROUND

In an airbag device installed in a vehicle, an airbag cover for covering a vehicle airbag is commonly provided. In the airbag cover, a tear line (linear groove) is provided in its inner wall surface. Accordingly, at the time of a vehicle collision, the tear line is ripped open, and then the vehicle airbag is allowed to be deployed and expanded outside the airbag cover. Here, as a technology for providing the tear line in the airbag cover by means of a post processing, for example, a technology which uses laser cuts is well known (for example, see U.S. Pat. No. 6,337,461 (incorporated by reference herein). In U.S. Pat. No. 6,337,461, it is suggested that the tear line can be formed using the laser cuts. In the case of mass-producing the airbag cover, however, a technology which is effective for conveniently forming the tear line in the airbag cover at low cost is highly demanded.

### SUMMARY

It is an object of at least one embodiment of the present invention to provide a manufacturing technology capable of suitably manufacturing an airbag cover for covering a vehicle airbag. The disclosed methods can be applied to manufacture airbags for various vehicles such as a car, a trolley car, a motorcycle (a vehicle equipped with a motorcycle seat), an aircraft, a vessel and the like.

A method of manufacturing an airbag cover according to one embodiment of the present invention relates to a method of manufacturing an airbag cover for covering a vehicle airbag installed in various vehicles. In the manufacturing method, an airbag cover is processed by means of ultrasonic processing mechanism, such that a linear groove is consecutively formed in the airbag cover. Typically, to the resultant airbag cover after molding, a processing is performed using the ultrasonic processing mechanism, thereby forming the linear groove. The linear groove means that a groove having a depth in a range of the plate thickness of a plate-shaped airbag cover is consecutively formed. The linear groove has a thickness relatively smaller than other portions of the airbag cover, and is referred to as a so-called tear line. At the time of a vehicle collision, the airbag cover is ripped open along the tear line such that the vehicle airbag is deployed and expanded.

In another embodiment of the present invention, the method of manufacturing an airbag cover of the present invention relates to a method of processing the airbag cover by means of the ultrasonic processing mechanism, and comprises at least a profiling teaching step and a processing step. In the present invention, in addition to the profiling teaching step and the processing step, other steps may be incorporated into the method of manufacturing the airbag cover.

Moreover, the ultrasonic processing mechanism may include a device having a configuration which is capable of transferring (providing) ultrasonic waves to a workpiece, thereby processing the workpiece. Typically, the ultrasonic processing mechanism includes a configuration which, by directing a blade-shaped member (ultrasonic processing blade) onto the workpiece, performs an ultrasonic processing (grinding processing) on the workpiece. As an example other that the blade-shaped member, ultrasonic processing mechanism having a bar shape or a plate shape may be used. Further, as a typical processing device which uses the ultrasonic processing mechanism, a device having a configuration in which motions by the ultrasonic processing blade with which the ultrasonic waves are provided are controlled by a processing robot may be exemplified. If so, the processing motions by the ultrasonic processing blade are controlled to follow a desired trace.

In the profiling teaching step of the present invention, a processing trace corresponding to the linear groove is formed in an airbag cover side member, and simultaneously, based on profiling data obtained by profiling an object to be taught alone the processing trace, processing data is taught to the ultrasonic processing mechanism. By performing the profiling teaching step in which the object to be taught profiles along the processing trace, processing data is taught to the ultrasonic processing mechanism.

Moreover, as the airbag cover side member in which the processing trace is formed, the airbag cover itself may be used or a supporting member for supporting the airbag cover from the bottom may be used. More specifically, the processing trace is formed in a processing surface of the airbag cover or an airbag cover supporting surface of the supporting member such that the object to be taught profiles along the processing trace.

In the present invention, as an aspect in which the object to be taught profiles along the processing trace, an aspect in which plural points are sequentially pressed by means of a front end portion of the object to be taught, such that the object to be taught moves, may be use. Alternatively, an aspect in which the object to be taught is made to move in a consecutive shape such that the front end portion of the object to be taught slides on the processing trace may be used. Further, the object to be taught which performs the profiling teaching may be comprised of the ultrasonic processing mechanism itself such as the processing blade which is used for the ultrasonic processing. Also, it may be comprised of a member to be exclusively used for teaching, which follows the ultrasonic processing mechanism. In the case in which the member to be exclusively used for teaching is used as the object to be taught, at the time of an actual processing, the ultrasonic processing mechanism may be changed for the member.

Further, in one embodiment of the present invention, profiling data obtained by the profiling motion of the object to be taught is stored in a control unit of the ultrasonic processing mechanism. At this time, profiling data may be stored automatically in the control unit of the ultrasonic processing mechanism according to the profiling motion of the object to be taught. Alternatively, profiling data may be substituted with a predetermined program language and directly input to the control unit.

Further, in still another embodiment of the present invention, as processing data which is to be taught to the ultrasonic processing mechanism, data such as a position, an angle, a moving trace, or a grinding pattern of the ultrasonic processing mechanism such as the processing blade is used. Processing data may accord with profiling data. Also, processing data is modified data to be obtained by modifying the profiling data. More specifically, to the case in which the supporting member is used. as the airbag cover side member, modified data to be obtained by modifying profiling data with respect to the thickness of the airbag cover is used as processing data.

In the processing step of one embodiment of the present invention, by controlling the ultrasonic processing mechanism based on processing data taught in the profiling teaching step, the linear groove is formed in the airbag cover. By performing the processing step, the linear groove having a depth in a range of the plate thickness of the airbag cover is formed with respect to the airbag cover for covering the vehicle airbag.

As described above, according to one embodiment of the invention, by the profiling teaching step in which the object to be taught profiles along the airbag cover side member, processing data of the airbag cover is created. Thus, it is effective in reducing the equipment cost, without needing a converter which converts CAD data into CAM data (NC operating data) or an NC control unit which performs a processing based on CAM data. Further, in the present invention, since processing data is obtained by profiling an actual object, it is effective in simplifying a teaching sequence for teaching the ultrasonic processing mechanism.

Yet another embodiment of the present invention for solving the above problem relates to a method of manufacturing an airbag cover according to the second aspect of the invention.

In the method of manufacturing an airbag cover according to one embodiment of the invention, the profiling teaching step of the present invention comprises at least the following first to fourth steps. In one embodiment of the present invention, each of the first to fourth steps may be further subdivided.

The first step is a step of profiling the object to be taught along the processing trace which is formed on the airbag cover supporting surface of the airbag cover supporting member serving as the airbag cover side member, thereby obtaining profiling data. In the first step, the airbag cover supporting member for supporting the airbag cover from its bottom is used as the airbag cover side member, and, at the time of the profiling motion of the object to be taught, the processing trace is formed in the airbag cover supporting surface of the airbag cover supporting member.

The second step is a step of modifying profiling data obtained in the first step with respect to the thickness of the airbag cover and teaching modified data to the ultrasonic processing mechanism. In the second step, the airbag cover supporting surface of the airbag cover supporting member serves as a reference surface for the profiling teaching. And then, on the assumption that the airbag cover is actually set on the airbag cover supporting surface (the reference surface), modified data is obtained by offsetting data by a predetermined thickness of the airbag cover from the airbag cover supporting surface. Typically, a position which is offset by a thickness in a bottom of the linear groove upward from the airbag cover supporting surface (the reference surface) is used as an assumed processing position of the airbag cover.

The third step is a step of controlling the ultrasonic processing mechanism based on the modified data taught in the second step to manufacture a trial airbag cover product. In the third step, the trial airbag cover product is manufactured as actual processed goods based on the modified data.

The fourth step is a step of measuring the dimensions of the trial airbag cover product manufactured in the third step and correcting the modified data based on measurement results to generate processing data. In the fourth step, the dimensions of the respective portions of the trial airbag cover product manufactured based on the modified data are measured, and the modified data is corrected based on the measurement. Moreover, in the case in which there is no need for correcting the modified data, the modified data itself is used as processing data. Meanwhile, in the case in which the correction of the modified data is needed, data after the modified data is corrected is used as processing data.

As described above, according to one embodiment of the present invention, only if processing data is obtained by profiling the object to be taught along the processing trace of the airbag cover supporting member, in the subsequent step, a desired linear groove can be formed in the airbag cover by controlling the ultrasonic processing mechanism based on processing data. Thus, it is possible to simplify the step of providing the linear groove in the airbag cover, and it is possible to reduce the manufacturing cost. The present invention is particularly effective in the case of mass-producing the airbag cover having the linear groove.

As described above, according to one embodiment of the present invention, in the case of manufacturing the airbag cover in which the linear groove is formed by means of the ultrasonic processing mechanism, the processing trace corresponding to the linear groove is formed in the airbag cover side member, and simultaneously, processing data is obtained by profiling the object to be taught along the processing trace. Thus, it becomes possible to simply manufacture the airbag cover at low cost.

It is to be understood that both the foregoing general description and the following detailed description are exemplary and explanatory only and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described as follows:

FIG. 1 is a diagram showing configuration of an airbag cover and an ultrasonic processing device which is used for the processing of the airbag cover, according to one embodiment of the present invention, and it also shows a state of an ultrasonic processing of the airbag cover which is performed by using the ultrasonic processing device.

FIG. 2 is a flowchart of an ultrasonic processing treatment step by means of the ultrasonic processing device according to the embodiment of the present invention.

FIG. 3 is a flowchart of a profiling teaching step in FIG. 2.

FIG. 4 is a flowchart of a processing step in FIG. 2.

FIG. 5 is a diagram schematically showing a treatment state in a step S13 of FIG. 3.

FIG. 6 is a diagram schematically showing a treatment state in step S22 of FIG. 4.

FIG. 7 is a diagram schematically showing treatment states in steps S23 and 26 of FIG. 4.

FIG. 8 is a diagram schematically showing a treatment state in a step S25 of FIG. 4.

FIG. 9 is a diagram schematically showing a treatment state in step S25 of FIG. 4.

FIG. 10 is a cross-sectional view showing a configuration of an airbag module, and it also shows an opened state of a tear line of an airbag cover.

### DETAILED DESCRIPTION

Hereinafter, an embodiment of the present invention will be described with reference to the drawings. One embodiment of the present embodiment relates to a technology for forming a tear line 102 in a cover back surface 101 of an airbag cover 100, which covers a vehicle airbag, using an ultrasonic processing.

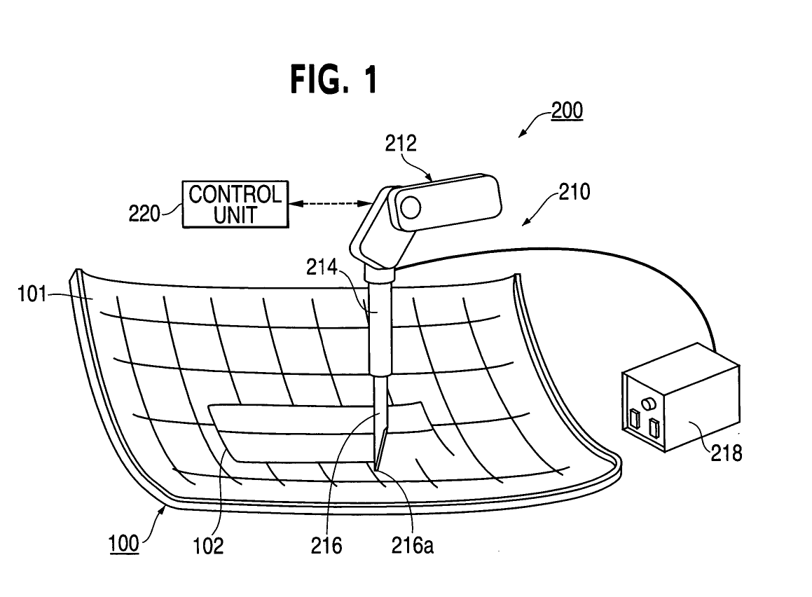

First, configurations of the airbag cover 100 and an ultrasonic processing device 200 will be described with reference to FIG. 1. Here, FIG. 1 is a diagram showing the configurations of the airbag cover 100 and the ultrasonic processing device 200, which is used to process the airbag cover 100, according to the present embodiment. Also, FIG. 1 shows a state of an ultrasonic processing of the airbag cover 10, the ultrasonic processing being performed using the ultrasonic processing device 200.

The airbag cover 100 shown in FIG. 1 has a three-dimensional plate shape and is made of a resin material such as a PP (polypropylene) material or a TPO (olefin-based elastomer) material. In a state in which the airbag cover 100 is provided, when a side facing a passenger is a front surface, the cover back surface 101 of the airbag cover 100 is defined as a surface of a back side thereof. The tear line 102 is a thinned portion which is provided to allow the airbag cover 100 to be ripped open when the vehicle airbag (a vehicle airbag 150 described below) is deployed and expanded. In one embodiment of the present embodiment, the tear line 102 is a linear groove which is formed in the cover back surface 101 of the airbag cover 100.

As shown in FIG. 1, the ultrasonic processing device or mechanism 200 comprises a driving unit 210 including a driving arm 212, and ultrasonic amplitude element 214, an ultrasonic processing blade 216 and an ultrasonic oscillator 218, and a control unit 220. Further, the ultrasonic processing device 200 of the present embodiment comprises displacement meters 221 and 222 described below, and an image examining camera 223.

The driving arm 212 is provided to configure a portion of a processing robot and is controlled based on an input signal from the control unit 220, such that a position, and angle, a processing trace, or the like of a blade front end 216a of the ultrasonic processing blade 216 can be adjusted.

The ultrasonic amplitude element 214 has a function of transferring ultrasonic waves oscillated in the ultrasonic oscillator 218 to the ultrasonic processing blade 216.

The ultrasonic processing blade 216 is a processing blade which is used to form the tear line 102 in the cover back surface 101 of the airbag cover 100. In one embodiment of the present embodiment, for example, a processing blade having a blade width of 1 [mm] may be used. Moreover, it is necessary that a member transfers (provide) the ultrasonic waves to a workpiece such that the processing of the workpiece may be performed. Thus, in addition to a blade-shaped member such as the ultrasonic processing blade 216, for example, a bar-shaped member or a plate-shaped member may be used.

The ultrasonic oscillator 218 is an oscillator having a function capable of oscillating an ultrasonic wave of a predetermined frequency. In one embodiment of the present embodiment, for example, an oscillator having a configuration capable of oscillating an ultrasonic wave of a frequency of 22 [kHz] may be used.

The control unit 220 is configured to store processing data obtained by the ultrasonic processing blade 216. Processing data may include data regarding a position, an angle, a moving trace, etc. of the driving arm 212 or a grinding pattern at the time of the ultrasonic processing and may be obtained in a profiling teaching step described below.

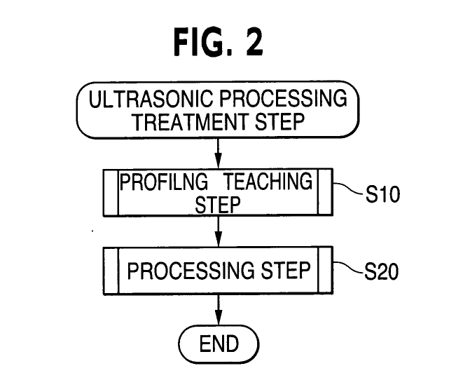

Next, a sequence of a processing step in which the tear line 102 is formed in the molded airbag cover 100 by means of a post processing and use of the above-mentioned ultrasonic processing device 200 will be described with reference to FIGS. 2 to 9.

FIG. 2 shows a flowchart of an ultrasonic processing treatment step by means of the ultrasonic processing device 200 of the present embodiment.

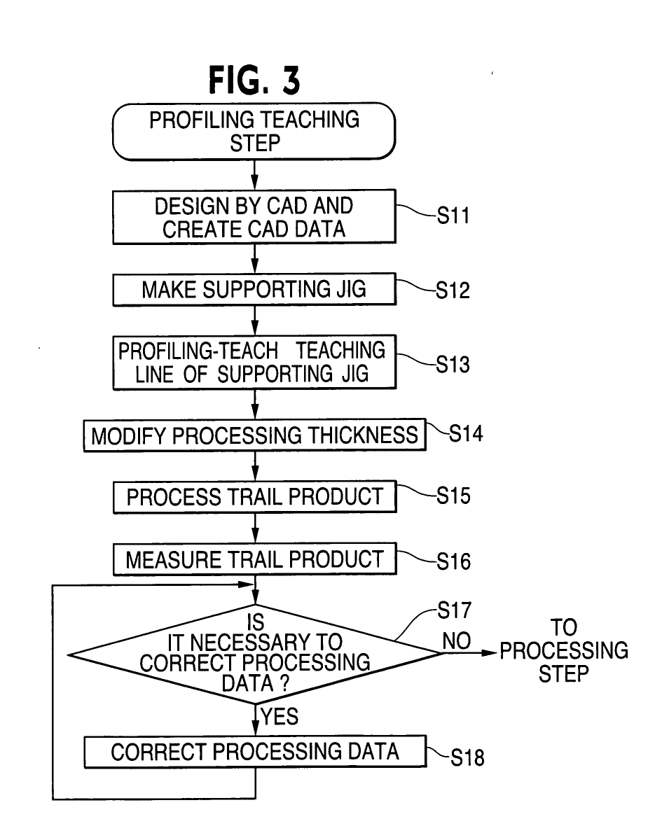

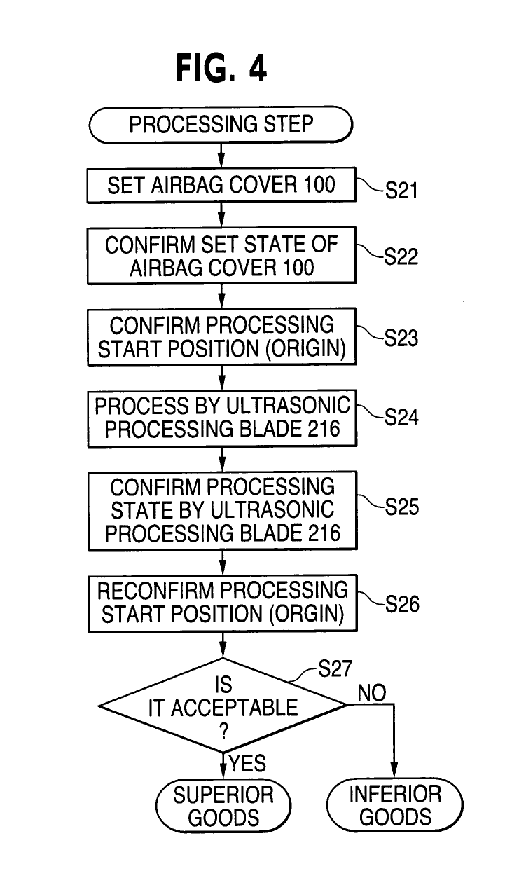

As shown in FIG. 2, the ultrasonic processing treatment step may be divided into a profiling teaching step (Step S10) in which processing data before the processing is analyzed, and a processing step (Step S20) in which the processing is actually performed using the ultrasonic processing device. In the profiling teaching step, steps S11 to S18 shown in FIG. 3 are sequentially performed. In the processing step, steps S21 to S27 shown in FIG. 4 are sequentially performed.

The profiling teaching step is a step of obtaining data, regarding a position, an angle, or a moving trace of the ultrasonic processing blade 216 at the time of the ultrasonic processing, as processing data, before an actual ultrasonic processing of the airbag cover 100 (tear line processing) is performed.

FIG. 3 shows a flowchart of the profiling teaching step in FIG. 2. As shown in FIG. 3, in the profiling teaching step, first, in the step S11, a design is performed by CAD (computer-aided design) based on design information of the airbag cover 100, and then CAD data is created. Here, for example, design information which is previously stored in a computer is displayed on a graphic display, and a user performs the design while viewing the screen. In the step S12, based on CAD data obtained in the step S11, an airbag cover supporting jig 130 having a shape which is suitable for the ultrasonic processing of the airbag cover 100 (tear line processing) is manufactured.

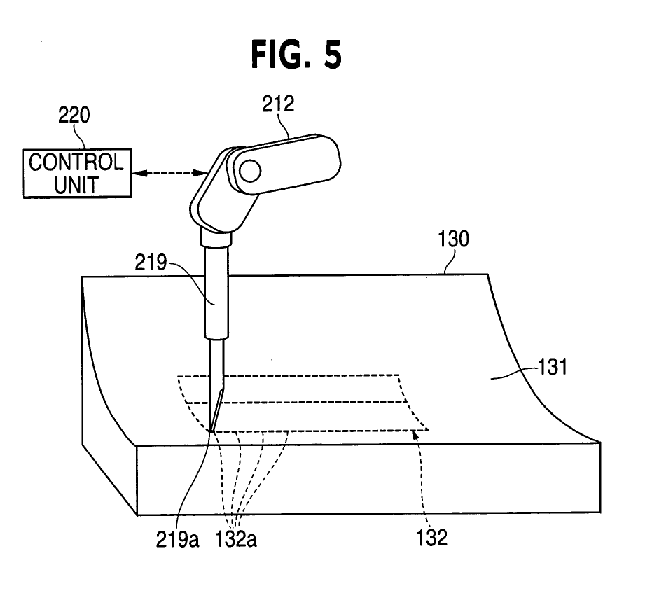

Here, FIG. 5 schematically shows a treatment state in the step S13 of FIG. 3. As shown in FIG. 5, the airbag cover supporting jig 130 manufactured in the step S12 of FIG. 3 has an airbag cover supporting surface 131 for supporting the airbag cover 100 from its bottom. The airbag cover supporting surface 131 of the airbag cover supporting jig 130 has a shape corresponding to a front surface of the airbag cover 100. Further, on the airbag cover supporting jig 130, in particular, an air suction mechanism, which is not shown, is mounted. The suction mechanism is operated, such that the airbag cover 100 is maintained in a suction state on the airbag cover supporting surface 131. Further, in the suction mechanism of the airbag cover supporting jig 130, a suction pressure detecting mechanism capable of detecting a suction pressure is provided. The airbag cover supporting jig 130 may serve as the airbag cover supporting member of the airbag cover side member.

In one embodiment of the present embodiment, when the step S13 of FIG. 3 is performed, a teaching line 132 is formed in the airbag cover supporting surface 131 of the airbag cover supporting jig 130. The teaching 132 is a processing trace corresponding to the tear line 102.

In the step S13 of FIG. 3, in order to obtain processing data by the ultrasonic processing blade 216, the profiling teaching is performed with respect to the control unit 220. More specifically, a member to be taught 219 profiles the teaching line 132 formed in the airbag cover supporting surface 131, such that profiling data regarding a position, an angle or a moving trace of the ultrasonic processing blade 216 at the time of the processing is obtained. The member to be taught 219 is a member which follows the ultrasonic processing blade 216 and which is installed in the driving arm 212, instead of the ultrasound processing blade 216, when the profiling teaching is performed. The member to be taught 219 moves such that a front end portion 219a thereof sequentially presses a plurality of teaching press points 132a on the teaching line 132, an thus the profiling teaching is made with respect to the control unit 220. And then, profiling data is automatically stored in the control unit 220. Moreover, the member of object to be taught 219 may be made to move in a consecutive shape such that the front end portion 219a slides on the teaching line 132, thereby performing the profiling teaching.

The step S13 is a step of profiling the member to be taught 219 along the teaching line 132 formed in the airbag cover supporting surface 131 of the airbag cover supporting jig 130, thereby obtaining (deriving) profiling data. The step S13 may serve as the first step.

In the step S13, profiling data obtained by the profiling teaching is changed into modified data, modified by a processing thickness of the airbag cover 100 in the step S14. That is, in the step S13, the airbag cover supporting surface 131 of the airbag cover supporting jig 130 serves as the reference surface for the profiling teaching. Thus, on the assumption that the airbag cover 100 is actually set on the airbag cover supporting surface 131 (the reference surface), data which is offset by a predetermined thickness of the airbag cover 100 from the airbag cover supporting surface 131 is made into modified data. Typically, a position which is offset upward by the thickness in a bottom of the tear line 102 from the airbag cover supporting surface 131 becomes an assumed processing position of the airbag cover 100. Modified data obtained in the step S14 is taught to (stored in) the control unit 220.

The step S14 is a step of modifying profiling data obtained in the step S13 with respect to the thickness of the airbag cover 100 and teaching modified data to the control unit 220, and may serve as the second step.

Next, in the step S15 of FIG. 3, based on modified data obtained in the step S14, the driving arm 212 is controlled via the control unit 220, and a trial product of the airbag cover 100 is actually manufactured. At this time, the member to be taught 219 used for the profiling teaching is changed for the ultrasonic processing blade 216. The manufacture of the trial airbag cover product is performed when an input signal corresponding to modified data obtained in the step S14 is transferred from the control unit 220 to the driving arm 212. The step S15 is a step of controlling the driving arm 212 based on modified data taught in the step S14 to manufacture the trial product of the airbag cover 100, and may serve as the third step.

Further, in the step S16, actual dimensions of the rial airbag cover product manufactured in the previous step S15 are measured. And then, in the step S17, it is determined whether or not there is a need for correcting processing data of the driving arm 212, based on dimension measurement results if the trial product in the step S16. If is determined that there is a need for correcting data (YES in the step S17), data is corrected in the step S18, and the process returns to the step S17. That is, modified data stored in the control unit 220 in the step S14 is updated into corrected data obtained in the step S18 and corrected data is taught to the control unit 220 as processing data. To the contrary, if it is determined that there is no need for correcting data (NO in the step S17), the profiling teaching step is ended, and then the process advances to the processing step of FIG. 4. In the case, modified data which is stored in the control unit 220 is not updated to corrected data and it itself is taught to the control unit 220 as processing data.

The steps S16 to S18 are steps of measuring dimensions of the trial product of the airbag cover 100 manufactured in the step S15 and correcting modified data based on measuring results to generate processing data. Steps S16 to S18 may serve as the fourth step.

As described above, the profiling teaching step of one embodiment of the present invention is a step of forming the teaching line 132 corresponding to the tear line 102 in the airbag cover supporting jig 130, and simultaneously, based on profiling data obtained by profiling the member to be taught 219 along the teaching line 132, teaching processing data to the control unit 220.

The processing step is a step of performing an actual ultrasonic processing (tear line processing) of the airbag cover 100, based on processing data obtained in the above-mentioned profiling teaching step (the steps S11 to S18).

FIG. 4 shows a flowchart of the processing step in FIG. 2. As shown in FIG. 4, in the processing step, first, in the step S21, the airbag cover 100 is set on the airbag cover supporting surface 131 of the airbag cover supporting jig 130 in FIG. 5. In the step S21, the suction mechanism (not shown) of the airbag cover supporting jig 130 is operated.

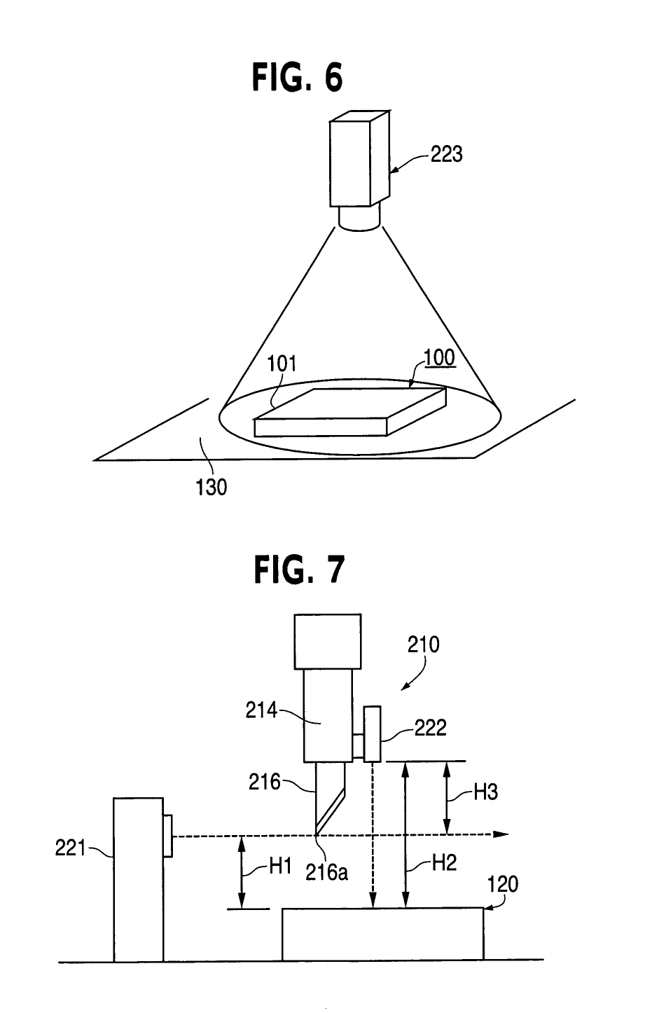

Further, in the step S22, a set state of the airbag cover 100 is confirmed. In the step S22, and adhesion state between the airbag cover 100 and the airbag cover supporting jig 130 is confirmed by means of the suction pressure which may be detected by the suction pressure detecting mechanism. Further, as shown in FIG. 6, by using the image examining camera 223, a positional variation of the airbag cover 100 is confirmed. Thus, it is possible for an operator to confirm the set state of the airbag cover 100.

Next, in the step S23, a processing start position (origin) of the ultrasonic processing blade 216 before the processing is confirmed. At the time of the confirmation, for example, the laser-type displaced meters 221 and 222 are used. The displacement meter 221 is provided at a base, and the displacement meter 222 is provided at the ultrasonic processing blade 216 of the driving unit 210. In such a configuration, as shown in FIG. 7, a height H1 (distance) from an upper surface of a reference block 120 up to the blade front end 216a of the ultrasonic processing blade 216 is detected by means of the displacement meter 221. Meanwhile, a height H2 (distance) from the upper surface of the reference block 120 up to the displacement meter 222 is detected by means of the displacement meter 222. And then, by calculating a difference (H2-H1) between the height H1 and the height H2 detected, a height H3 from the displacement meter 222 up to the blade front end 216a of the ultrasonic processing blade 216 is obtained (derived). Thus, the processing start position (the origin) of the ultrasonic processing blade 216 is determined.

Moreover, the number of detection points of the height H1 by means of the displacement meter 221 and the height H2 by means of the displacement meter 222 in the step S23 may be set in consideration of a shape of the airbag cover 100 or the like. For example, as the shape of the airbag cover 100 is complex, it is preferable to increase the number of the detection points of the heights H1 and H2.

Next, in the step S24, the actual ultrasonic processing (tear line processing) is started by means of the ultrasonic processing blade 216. The processing is performed when an input signal corresponding to processing data obtained in the step S14 or processing data updated in the step S18 is transferred from the control unit 220 to the driving arm 212. At this time, the ultrasonic oscillator 218 oscillates ultrasonic waves of frequencies of 22 [kHz], and the ultrasonic waves are transferred to the ultrasonic processing blade 216 via the ultrasonic amplitude element 214. And then, based on the input signal from the control unit 220, the driving arm 212 is controlled, and the position, the angle or the moving trace of the blade front end 216a of the ultrasonic processing blade 216 is adjusted. Thus, the processing motions by the ultrasonic processing blade 216 are controlled to follow a desired trace. A processing speed by the ultrasonic processing blade 216 can be set to, for example, 30 [mm/sec]. Such a processing speed is one and a half times faster than a processing speed by a laser processing, that is, 20 [mm/sec]. Therefore, it is effective in improving production efficiency of the airbag cover 100.

Moreover, processing conditions, such as the frequency of the ultrasonic wave to be oscillated from the ultrasonic oscillator 218 or the processing speed of the ultrasonic processing blade 216, can be suitably set based on conditions of the workpiece, such as the material of the airbag cover or a plate thickness.

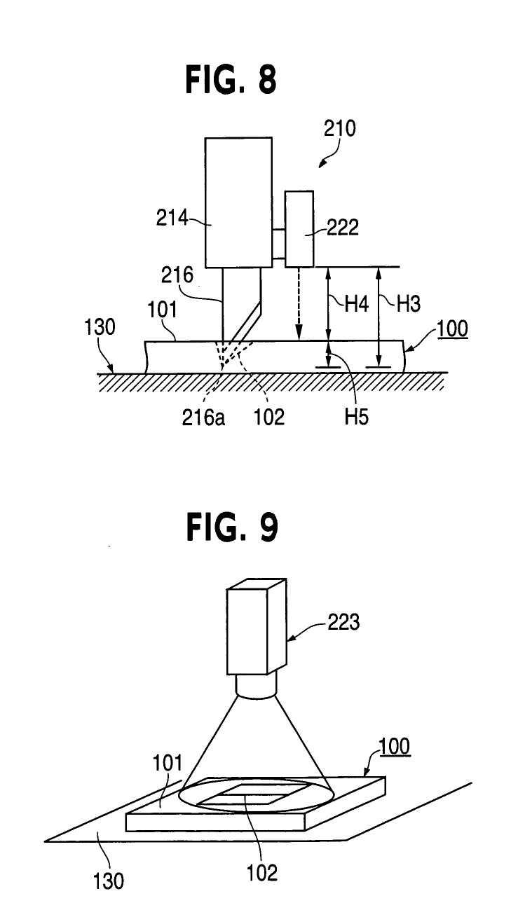

In the step S25, at the time of the ultrasonic processing by means of the ultrasonic processing blade 216 in the step S24 (during processing), a processing state by means of the ultrasonic processing blade 216 is confirmed. Here, as shown in FIG. 8, a height H4 (distance) from the cover back surface 101 of the airbag cover 100 up to the displacement meter 222 is detected by means of the displacement meter 222.

And then, by calculating a difference between the height H3 which is previously detected in the step S23 (the height from the displacement meter 222 up to the blade front end 216a of the ultrasonic processing blade 216) and the height H4, a processing depth (grinding depth) H5 of the tear line 102 is obtained (derived). As described above, in the present embodiment, the processing depth H5 of the tear line 102 is not directly detected. Instead, the processing depth H5 of the tear line 102 is indirectly inferred based on other detection information. Further, based on the processing depth H5 and data regarding controls of the control unit 220, it is possible to confirm a remaining thickness of the airbag cover 100 at any positions of the tear line 102. Thus, the airbag cover 100 in which the tear line 102 having a desired processing depth is consecutively formed is manufactured. If the shape of the airbag cover as the workpiece is three-dimensionally complex, there may be a case in which it is difficult to detect directly the processing depth H5 of the tear line 102. However, in the present embodiment, information regarding the processing depth H5 of the tear line 102 is detected hourly, and thus the processing depth H5 is derived with high reliability. Therefore, it is effective in reliably processing the tear line 102 having a desired depth, in particular, with respect to the three-dimensionally molded airbag cover.

Moreover, in the step S25, the number of detection points of the height H4 by means of the displacement meter 222 may be suitably set in consideration of the shape of the airbag cover 100 of the like. For example, as the shape of the airbag cover 100 is complex, it is possible to increase the number of the detection points of the height H4. Further, as shown in FIG. 9, by using the image examining camera 223, the processing trace of the tear line 102 is confirmed.

In the step S26, the processing start position (the origin) of the ultrasonic processing blade 216 is reconfirmed by the same operation as that of the step S23.

Finally, in the step S27, it is determined whether or not the ultrasonic processing of the airbag cover 100 is acceptable. If it is determined that the ultrasonic processing of the airbag cover 100 is acceptable (YES in the step S27), the airbag cover 100 is referred to as “superior goods”. To the contrary, if it is determined that the ultrasonic processing of the airbag cover 100 is not acceptable (NO in the step S27), the airbag cover 100 is referred to as “inferior goods”.

Thus, by repetitively performing the steps S21 to S27, the airbag covers 100 in each of which the tear line 102 is formed in the cover back surface 101 by means of the ultrasonic processing are mass-produced.

As described above, the processing step of one embodiment of the present invention is a step of controlling the ultrasonic processing device 200 based on processing data taught in the profiling teaching step, and forming the tear line 102 to the airbag cover 100.

As described above, according to the present embodiment, processing data of the airbag cover 100 is created by means of the profiling teaching step in which the member to be taught 219 profiles the airbag cover supporting jig 130. Thus, without needing a converter which converts CAD data into CAM data (NC operating data) or an NC control unit which performs the processing based on CAM data, it is possible to reduce the equipment coat. Further, in the present invention, since processing data is obtained by profiling an actual thing, it is effective to simplify the teaching sequence.

Further, according to the above-mentioned embodiment, in the profiling teaching step, only if processing data is obtained, in the subsequent step, the desired tear line 192 can be formed in the airbag cover 100 by controlling the driving arm 212 based on processing data. Thus, it is possible to simplify the step of providing the tear line 102 in the airbag cover 100, and it is possible to reduce the manufacturing cost. The ultrasonic processing device 200 of the present embodiment is particularly effective in the case of mass-producing the airbag covers 100 each having the tear line 102.

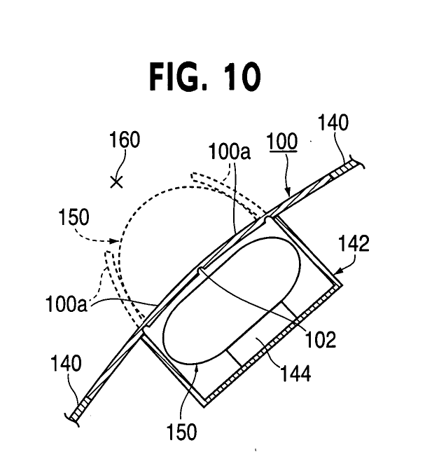

Moreover, the airbag cover 100 manufactured by the above-mentioned manufacturing method may be incorporated into a vehicle, for example, as shown in FIG. 10. That is, an airbag module comprises the airbag cover 100, an instrument panel 140 in which the airbag cover 100 is disposed, a vehicle airbag 150, a housing (retainer) 142 in which the vehicle 150 is housed in a folded state, and a gas supply 144 which is embedded in the housing 142 and supplies an expansion gas to the vehicle airbag 150.

At the time of a vehicle collision, the gas supply device 144 is operated, and then, by means of the expansion gas supplied from the gas supply device 144, the vehicle airbag 150 is deployed. When the vehicle airbag 150 is deployed and expanded, the airbag cover 100 is ripped open along the tear line 102. Here, for example, a pair of deploying doors 100a is disposed toward a cover front surface in a double-swinging manner. Thus, the vehicle airbag 150 is deployed via the deploying doors 100a in deployed states to the outside of the airbag cover 100, and deployed and expanded while projecting toward a passenger protection region 160 which is formed in front of a passenger.

The present invention is not limited only to the above-mentioned embodiments, but various modifications or applications can be made. For example, the following embodiments may be implemented.

In one embodiment of the present invention, the case in which the teaching line 132 for the profiling teaching which corresponds to the tear line 102 is formed in the airbag cover supporting surface 131 of the airbag cover supporting jig 130 is described. Alternatively, according to another embodiment of the present invention, the teaching line of the profiling teaching may be formed in the airbag cover 100 itself.

Further, in one embodiment of the present invention, the case in which, at the time of the profiling teaching, instead of the ultrasonic processing blade 216, the member to be taught 219 is used for the profiling teaching is described. Alternatevely, in yet another embodiment of the present invention, the ultrasonic processing blade 216 itself may be used for the profiling teaching.

In addition, in one embodiment of the present invention, the case in which profiling data obtained by profiling the member to be taught 219 along the teaching line 132 is automatically stored in the control unit 220 is described. Alternatively, according to still another embodiment of the present invention, profiling data obtained by profiling the member to be taught 219 along the teaching line 132 may be substituted with other program language and may be directly stored in the control unit 220.

The priority application, Japanese Patent Application No. 2004-042540 filed Feb. 19, 2004, including the specification, drawings, claims and abstract, is incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be set forth in the following claims.

1. A method of manufacturing a cover for a vehicle airbag, wherein the cover includes a linear groove having a depth in a range of the plate thickness of the cover is formed by an ultrasonic processing mechanism, the method comprising:
forming a processing trace corresponding to the linear groove in an airbag cover side member;
profiling an object to be taught along the processing trace to obtain profiling data;
teaching processing data to the ultrasonic processing mechanism based on the profiling data; and
forming the linear groove in the airbag cover by controlling the ultrasonic processing mechanism based on processing data taught in the teaching step.

2. The method of manufacturing of claim 1, wherein the teaching step further comprises profiling the object to be taught along the processing trace formed on an airbag cover supporting surface of an airbag cover supporting member serving as the airbag cover side member to obtain profiling data.

3. The method of claim 2, wherein the teaching step further comprises modifying profiling data obtained in the first step with respect to the thickness of the airbag cover and teaching modified data to the ultrasonic processing mechanism.

4. The method of claim 3, wherein the teaching step further comprises manufacturing a trial airbag cover product by controlling the ultrasonic processing mechanism based on the modified data taught in the second step.

5. The method of claim 4, wherein the teaching step further comprises measuring dimensions of the trial airbag cover product manufactured in the third step and correcting the modified data based on the measurement to generate processing data.
